(19) United States
(12) Patent Application Publication
(10) Pub. No.: US 2015/0278848 A1
(43) Pub. Date: Oct. 1, 2015

(54) APPARATUS AND METHOD FOR GENERATING ADVERTISING WALL

(71) Applicant: Wistron Corporation, New Taipei City (TW)

(72) Inventor: Fu-Ming Wang, New Taipei City (TW)

(21) Appl. No.: 14/561,321

(22) Filed: Dec. 5, 2014

(30) Foreign Application Priority Data
Mar. 27, 2014 (CN) 201410119231.4

(51) Int. Cl. G06Q 30/02

(52) U.S. Cl. CPC G06Q 30/0241

(57) ABSTRACT

An apparatus and a method for generating an advertising wall are disclosed. The advertising wall generating apparatus comprises an inputting apparatus, a processor and an outputting apparatus. The inputting apparatus inputs a filtering condition. The processor edits an advertising wall according to the filtering condition. The advertising wall comprises at least an advertising field on which an advertising message and a location number are shown. The processor determines whether the advertising field has the advertising message. If the advertising field has the advertising message, the processor shows a status frame around the advertising field to indicate an advertising status of the advertising message.

This application claims the benefit of People's Republic of China application Serial No. 201410119231.4, filed Mar. 27, 2014, the subject matter of which is incorporated herein by reference.

### BACKGROUND OF THE INVENTION

1. Field of the Invention

The invention relates in general to a generation apparatus and more particularly to an apparatus and a method for generating an advertising wall.

2. Description of the Related Art

Various advertisements can be seen in all sorts of streets to advocate new products or increase the visibility and popularity of shops and products. As the modern technologies spread fast, shops or manufacturers can transfer advertising messages to people through advertising fields of advertising walls. Particularly, with the increasing popularity of electronic devices in the market, the advertising messages of advertising walls can be transferred to consumers through smart phones, mobile communication devices, Internet TVs or PCs to promote products or services. However, current design of the advertising walls still cannot help the user to intuitively understand the advertising location of an advertising field and associated advertising status, as such, the advertising walls are still inconvenient to use.

### SUMMARY OF THE INVENTION

The invention is directed to an apparatus and a method for generating an advertising wall capable of helping users to intuitively understand the advertising location of an advertising field and associated advertising status and making the advertising walls more convenient to use.

According to an embodiment of the present invention, an advertising wall generating apparatus is disclosed. The advertising wall generating apparatus comprises an inputting apparatus, a processor and an outputting apparatus. The processor inputs a filtering condition. The processor edits an advertising wall according to the filtering condition. The advertising wall comprises at least an advertising field on which an advertising message and a location number are shown. The processor determines whether the advertising field has the advertising message. If the advertising field has the advertising message, the processor shows a status frame around the advertising field to indicate an advertising status of the advertising message. The outputting apparatus outputs the advertising wall.

According to another embodiment of the present invention, an advertising wall generating method is disclosed. The advertising wall generating method comprises following steps. A filtering condition is inputted. An advertising wall is edited according to the filtering condition, wherein the advertising wall comprises at least an advertising field on which an advertising message and a location number are shown. Whether the advertising field has the advertising message is determined. If the advertising field has the advertising message, a status frame is shown around the advertising field to indicate an advertising status of the advertising message. The advertising wall is outputted.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an advertising wall generating apparatus according to the first embodiment.

FIG. 2 is a schematic diagram of an advertising wall whose advertising field has an advertising message.

FIG. 3 is a schematic diagram of setting filtering condition.

FIG. 4 and FIG. 5 are procedures of a flowchart of an advertising wall generating method according to a first embodiment.

FIG. 6 is a display status of an advertising wall.

FIG. 7 is another display status of an advertising wall.

### DETAILED DESCRIPTION OF THE INVENTION

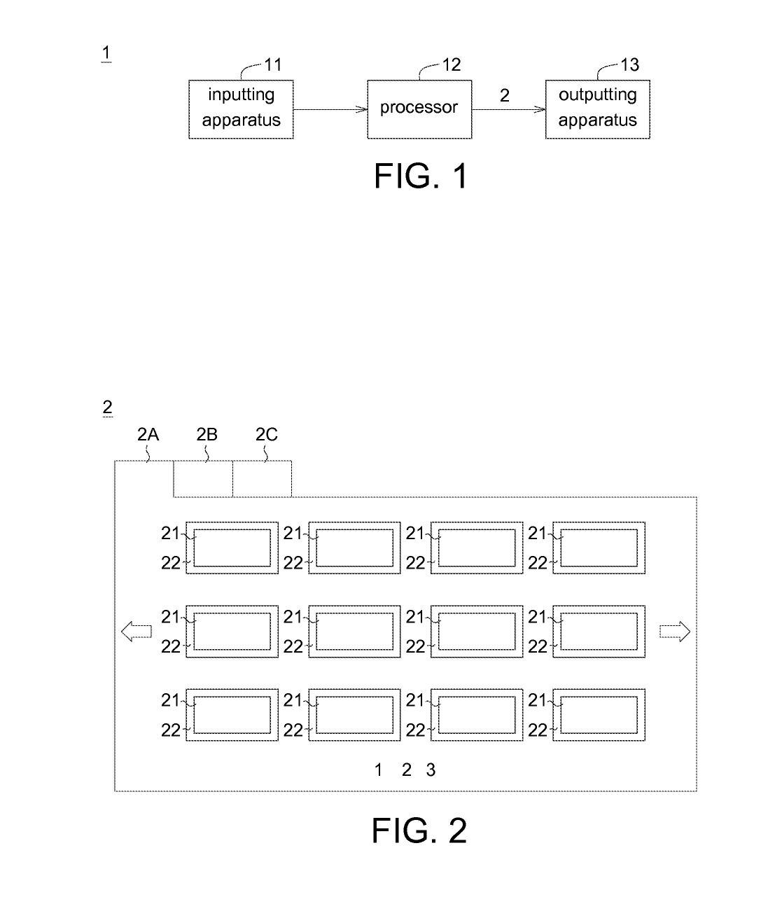

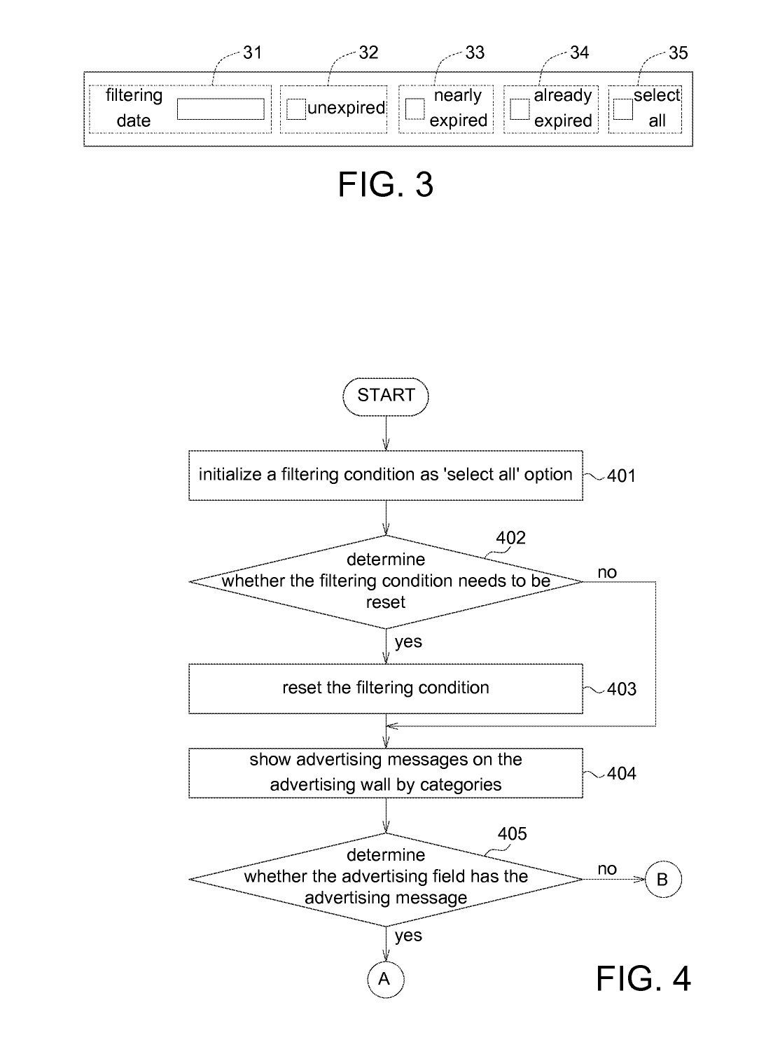

Refer to FIG. 1, FIG. 2 and FIG. 3. FIG. 1 is a schematic diagram of an advertising wall generating apparatus according to the first embodiment. FIG. 2 is a schematic diagram of an advertising wall whose advertising field has an advertising message. FIG. 3 is a schematic diagram of setting filtering condition. The advertising wall generating apparatus 1 comprises an inputting apparatus 11, a processor 12 and an outputting apparatus 13. The inputting apparatus 11 can be realized by such as a keyboard, a mouse or a touch screen. The outputting apparatus 13 can be realized by such as a screen or an LED apparatus. The inputting apparatus 11 inputs a filtering condition. The filtering condition is, for example, a filtering date 31, an ‘unexpired’ option 32, a ‘nearly expired’ option 33, an ‘already expired’ option 34 or a ‘select all’ option 35. The processor 12 selects an advertising message corresponding to the advertising wall 2 according to the filtering date. For example, the advertising message corresponds to a start date and a due date. If the filtering date of the advertising message is between the start date and due date, the processor 12 selects the advertising message. If the filtering date of the advertising message is later than the due date, this indicates that the advertising message is an expired advertising message. If the filtering date of the advertising message is later than the due date and there are no newly added advertising messages, the processor 12 continues to select the expired advertising message. When the advertising wall 2 is shown in an internal management end, the expired advertising message can be clearly shown without being covered with a semi-transparent filter, and the management of the advertising wall 2 is made more convenient. The internal management end is, for example, a decision maker's or an internal management staff's display apparatus. Relatively, when the advertising wall 2 is outputted to an external user end, the processor 12 further covers the expired advertising message with a semi-transparent filter to blur the expired advertising message, such that the expired advertising message will not be clearly shown in the external user end. The external user end is, for example, an external client's or a consumer's display apparatus.

In the embodiment, the advertising wall 2 comprises categories 2A, 2B and 2C. The categories 2A, 2B and 2C are such as text advertisement, image advertisement or video advertisement respectively. Each of the categories 2A, 2B and 2C comprises at least an advertising field 21, which shows an advertising message and a corresponding location number. For example, if the advertising wall 2 has twelve advertising fields 21, the location numbers shown at the right bottom of the advertising field 21 are serial numbers 1˜12. The advertising field 21 can show one or more than one advertising message in a time session. Besides, the left and right sides of the advertising wall 2 can have a left arrow sign and a right arrow sign with which more advertising messages can be shown. In addition, when the advertising wall 2 is shown on a Tablet PC or any other electronic device equipped with a touch screen, the user can slide his/her finger on the screen to show more advertising messages. Also, the bottom of the advertising wall 2 can further comprise a page number with which more advertising messages can be shown. Or, when the advertising wall 2 is shown on a Tablet PC or any other electronic device equipped with a touch screen, the user can click the advertising field 21 on the screen, and the corresponding page will be popped out accordingly.

The processor 12 determines whether the advertising field 21 has an advertising message. If the advertising field 21 has the advertising message, the processor 12 shows a status frame 22 around the advertising field 21 to indicate an advertising status of the advertising message. The advertising status is, for example, ‘unexpired’, ‘nearly expired’ or ‘already expired’. If the advertising field 21 does not have the advertising message, the advertising field 21 shows gray color. The status frame 22 can indicate the advertising status of the advertising message by using different colors. For example, if the advertising status of the advertising message is ‘unexpired’, the status frame 22 shows green color. If the advertising status of the advertising message is ‘nearly expired’, the status frame 22 shows yellow color. If the advertising status of the advertising message is ‘already expired’, the status frame 22 shows red color. For example, if the due date is earlier than the filtering date, this indicates that the advertising message is already expired and red color is shown on the status frame. If the due date is later than the filtering date and the due date is only one day later than the filtering date, this indicates that the advertising message is nearly expired and yellow color is shown on the status frame. If the due date is later than the filtering date and the due date is at least one day later than the filtering date, this indicates that the advertising message is unexpired and green color is shown on the status frame. For convenience of elaboration, in the above embodiments, whether the advertising message is an unexpired advertising message is determined according to whether the due date is at least one day later than the filtering date. However, the actual application is not limited thereto. In some embodiments, whether the advertising message is an unexpired advertising message can be determined according to whether the due date is two days, three days or other number of days earlier than the filtering date.

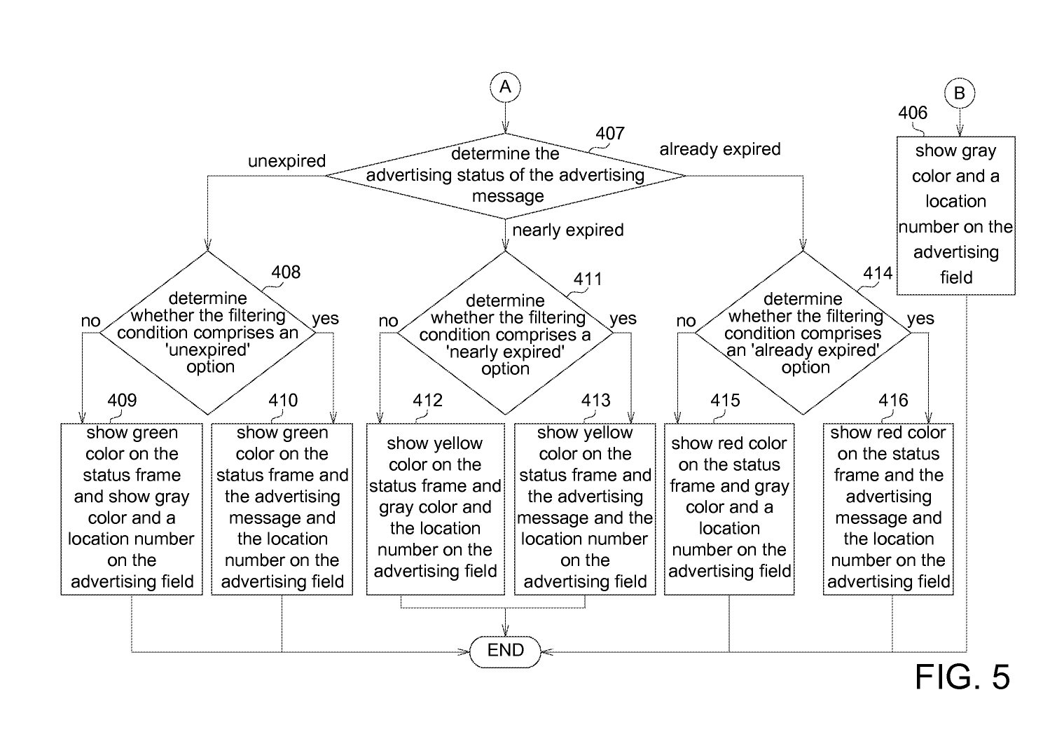

Refer to FIG. 1, FIG. 4 and FIG. 5. FIG. 4 and FIG. 5 are procedures of a flowchart of an advertising wall generating method according to a first embodiment. Firstly, the method begins at step 401, in which a filtering condition is initialized as ‘select all’ option 35. Unexpired advertisement, nearly expired advertisement and already expired advertisement are shown on the advertising wall 2. Next, the method proceeds to step 402, whether the filtering condition needs to be reset is determined by the processor 12. If the filtering condition needs to be reset, the method proceeds to step 403, the filtering condition is reset by the processor 12. Then, the method proceeds to step 404. If the filtering condition does not need to be reset, the method proceeds to step 404, advertising messages are shown on the advertising wall 2 by categories. Then, the method proceeds to step 405, whether the advertising field has an advertising message is determined by the processor 12. If the advertising field does not have the advertising message, the method proceeds to step 406, gray color and a location number are shown on the advertising field.

Conversely, if the advertising field has the advertising message, the method proceeds to step 407, whether the advertising status of the advertising message is ‘unexpired’, ‘nearly expired’ or ‘already expired’ is determined by the processor 12. If the advertising status is ‘unexpired’, the method proceeds to step 408, whether the filtering condition comprises an ‘unexpired’ option is further determined by the processor 12. If the filtering condition does not comprise the ‘unexpired’ option, the method proceeds to step 409, green color is shown on the status frame and gray color and a location number are shown on the advertising field. Conversely, if the filtering condition comprises the ‘unexpired’ option, the method proceeds to step 410, green color is shown on the status frame and the advertising message and the location number are shown on the advertising field.

If the advertising status is ‘nearly expired’, the method proceeds to step 411, whether the filtering condition comprises a ‘nearly expired’ option is further determined by the processor 12. If the filtering condition does not comprise the ‘nearly expired’ option, the method proceeds to step 412, yellow color is shown on the status frame and gray color and the location number are shown on the advertising field. Conversely, if the filtering condition comprises the ‘nearly expired’ option, the method proceeds to step 413, yellow color is shown on the status frame and the advertising message and the location number are shown on the advertising field.

If the advertising status is ‘already expired’, the method proceeds to step 414, whether the filtering condition comprises an ‘already expired’ option is further determined by the processor 12. If the filtering condition does not comprise the ‘already expired’ option, the method proceeds to step 415, red color is shown on the status frame and gray color and a location number are shown on the advertising field. Conversely, if the filtering condition comprises the ‘already expired’ option, the method proceeds to step 416, red color is shown on the status frame and the advertising message and the location number are shown on the advertising field. In an embodiment, after the advertising message expires, the processor 12 can further determine whether there are any newly added advertising messages. If there is a newly added advertising message, the advertising field shows the newly added advertising message. Conversely, if there are no newly added advertising messages, the processor 12 continues to show the old advertising message and changes the status frame 22 into red color.

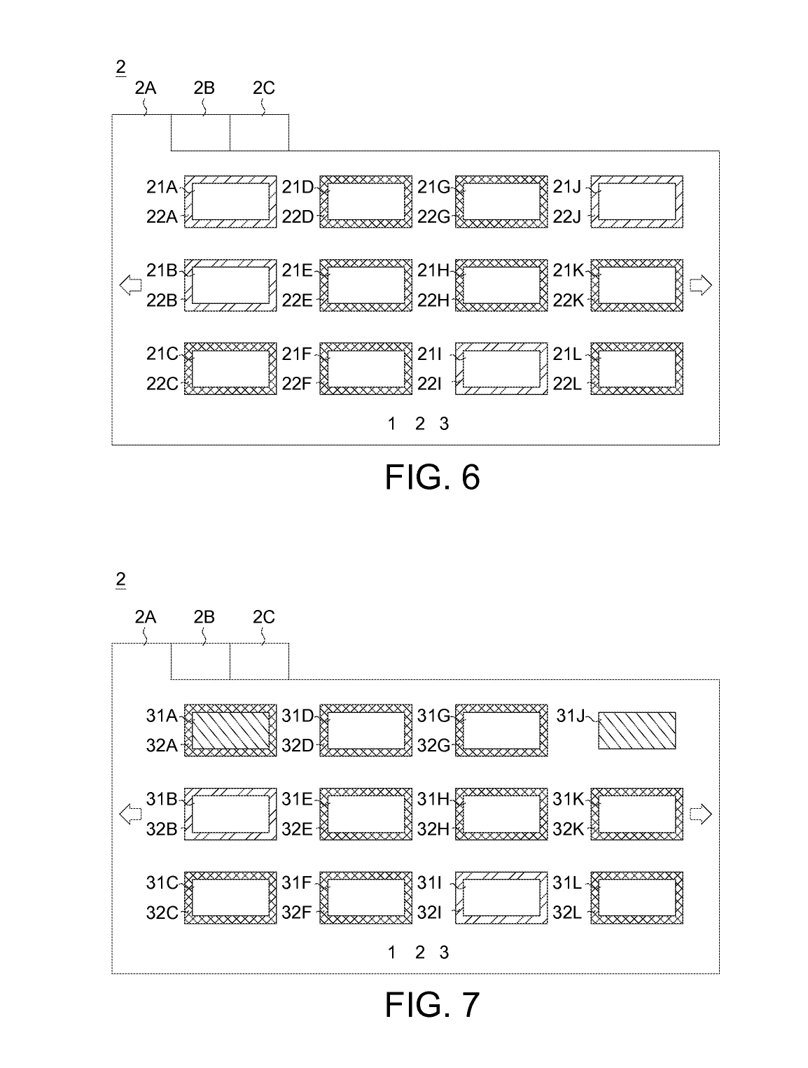

Referring to FIG. 6, a display status of an advertising wall is shown. In FIG. 6, advertising fields are exemplified by twelve advertising fields 21A˜21L whose location numbers are respectively designated by serial numbers 1˜12. In FIG. 6, status frames of the advertising field 21A˜21L are respectively exemplified by status frames 22A˜22L. Green status frames 22C˜22H and 22K˜22L are respectively shown around the advertising fields 21C˜21H and 21K˜21L to indicate that the associated advertising messages are unexpired. Yellow status frames 22B and 22I are respectively shown around the advertising fields 21B and 21I to indicate that associated advertising messages are nearly expired. Red color status frames 22A and 22J are respectively shown around the advertising fields 21A and 21J to indicate that the associated advertising messages are already expired. Thus, decision makers or users can understand the advertising fields of the advertising wall 2 and associated advertising status more intuitively and search and position advertisements more conveniently. Meanwhile, the decision makers or the users can make decision according to the advertising status.

Referring to FIG. 7, a display status of another advertising wall is shown. In FIG. 7, advertising fields exemplified by twelve advertising fields 31A˜31L whose location numbers respectively are serial numbers 1˜12. In FIG. 7, status frames of the advertising fields 31A, 31C˜31H and 31K˜31L are respectively exemplified by status frames 32A, 32C˜32H and 32K˜32L. Since the advertising fields 31C˜31H and 31K˜31L have advertising messages and are unexpired, green color is shown on the status frames 32C˜32H and 32K˜32L and advertising messages and location numbers are shown on the advertising fields 31C˜31H and 31K˜31L. Since the advertising field 31B and 31I have advertising messages and are nearly expired, yellow color is shown on the status frames 32B and 32I and advertising messages and location numbers are shown on the advertising fields 31B and 31I. Since the advertising field 31A has advertising message and is unexpired, green color is sown on the status frame 32A. Since the advertising field 31A does not have any advertising messages for the time being, not any advertising messages but gray color and a location number are shown on the advertising field 31A. Since the advertising field 31J does not have any advertising messages, not any status frames but gray color and a location number are shown on the advertising field 31J.

The apparatus and method for generating an advertising wall disclosed in above embodiments help decision makers or users to understand the advertising field of the advertising wall 2 and associated advertising status more intuitively and to search and position advertisements more conveniently. Meanwhile, the decision makers or the users can make decision according to the advertising status.

While the invention has been described by way of example and in terms of the preferred embodiment(s), it is to be understood that the invention is not limited thereto. On the contrary, it is intended to cover various modifications and similar arrangements and procedures and the scope of the appended claims therefore should be accorded the broadest interpretation so as to encompass all such modifications and similar arrangements and procedures.

What is claimed is:

1. An advertising wall generating apparatus, comprising:
an inputting apparatus for inputting a filtering condition;
a processor for editing an advertising wall according to the filtering condition, wherein the advertising wall comprises at least an advertising field on which an advertising message and a location number are shown and the processor determines whether the advertising field has the advertising message; if the advertising field has the advertising message, the processor shows a status frame around the advertising field to indicate an advertising status of the advertising message; and
an outputting apparatus for outputting the advertising wall.

2. The advertising wall generating apparatus according to claim 1, wherein:
the advertising wall comprises a plurality of categories each comprising at least a respective advertising field; and
if the advertising field does not have the advertising message, a first color and the location number are shown on the advertising field.

3. The advertising wall generating apparatus according to claim 2, wherein if the advertising field has the advertising message, the processor determines the advertising status of the advertising message; if the advertising status is ‘unexpired’, the processor determines whether the filtering condition comprises an ‘unexpired’ option; if the filtering condition does not comprise the ‘unexpired’ option, a second color is shown on the status frame and the first color and the location number are shown on the advertising field; the first color and the second color are not the same.

4. The advertising wall generating apparatus according to claim 3, wherein if the filtering condition comprises the ‘unexpired’ option, the second color is shown on the status frame and the advertising message and the location number are shown on the advertising field.

5. The advertising wall generating apparatus according to claim 3, wherein if the advertising status is ‘nearly expired’, the processor determines whether the filtering condition comprises a ‘nearly expired’ option; if the filtering condition does not comprise the ‘nearly expired’ option, a third color is shown on the status frame and the first color and the location number are shown on the advertising field; the first color, the second color and the third color are not the same.

6. The advertising wall generating apparatus according to claim 5, wherein if the filtering condition comprises the ‘nearly expired’ option, the third color is shown on the status frame, and the advertising message and the location number are shown on the advertising field.

7. The advertising wall generating apparatus according to claim 5, wherein if the advertising status is ‘already expired’, the processor determines whether the filtering condition comprises an ‘already expired’ option, a fourth color is shown on the status frame; if the filtering condition does not comprise the ‘already expired’ option, the first color and the location number are shown on the advertising field; the first color, the second color, the third color and the fourth color are not the same.

8. The advertising wall generating apparatus according to claim 7, wherein if the filtering condition comprises the ‘already expired’ option, the fourth color is shown on the status frame and the advertising message and the location number are shown on the advertising field.

9. The advertising wall generating apparatus according to claim 1, wherein the filtering condition comprises a filtering date and the advertising message corresponds to a start date and a due date; if the filtering date is between the start date and the due date, the processor selects the advertising message.

10. The advertising wall generating apparatus according to claim 1, wherein the filtering condition comprises a filtering date and the advertising message corresponds to a due date; if the filtering date is later than the due date, this indicates that the advertising message is an expired advertising message; if the filtering date is later than the due date and there are no newly added advertising messages, the processor selects the expired advertising message; if the expired advertising message is shown in an external user end, the processor covers the expired advertising message with a semi-transparent filter.

11. An advertising wall generating method, comprising:
inputting a filtering condition;
editing an advertising wall according to the filtering condition, wherein the advertising wall comprises at least an advertising field on which an advertising message and a location number are shown;
determining whether the advertising field has the advertising message;
showing a status frame around the advertising field to indicate an advertising status of the advertising message if the advertising field has the advertising message; and
outputting the advertising wall.

12. The advertising wall generating method according to claim 11, wherein:
the advertising wall comprises a plurality of categories each comprising at least a respective advertising field; and
if the advertising field does not have the advertising message, a first color and the location number are shown on the advertising field.

13. The advertising wall generating method according to claim 12, wherein if the advertising field has the advertising message, the advertising status of the advertising message is determined; if the advertising status is ‘unexpired’, whether the filtering condition comprises an ‘unexpired’ option is determined; if the filtering condition does not comprise the ‘unexpired’ option, a second color is shown on the status frame and the first color and the location number are shown on the advertising field; the first color and the second color are not the same.

14. The advertising wall generating method according to claim 13, wherein if the filtering condition comprises the ‘unexpired’ option, the second color is shown on the status frame and the advertising message and the location number are shown on the advertising field.

15. The advertising wall generating method according to claim 13, wherein if the advertising status is ‘nearly expired’, whether the filtering condition comprises a ‘nearly expired’ option is determined; if the filtering condition does not comprise the ‘nearly expired’ option, a third color is shown on the status frame and the first color and the location number are shown on the advertising field; the first color; the second color and the third color are not the same.

16. The advertising wall generating method according to claim 15, wherein if the filtering condition comprises the ‘nearly expired’ option, the third color is shown on the status frame, and the advertising message and the location number are shown on the advertising field.

17. The advertising wall generating method according to claim 15, wherein if the advertising status is ‘already expired’, whether the filtering condition comprises an ‘already expired’ option is determined; if the filtering condition does not comprise the ‘already expired’ option, a fourth color is shown on the status frame and the first color and the location number are shown on the advertising field; the first color, the second color, the third color and the fourth color are not the same.

18. The advertising wall generating method according to claim 17, wherein if the filtering condition comprises the ‘already expired’ option, the fourth color is shown on the status frame and the advertising message and the location number are shown on the advertising field.

19. The advertising wall generating method according to claim 11, wherein the filtering condition comprises a filtering date and the advertising message corresponds to a start date and a due date; the filtering date is between the start date and the due date, the advertising message is selected.

20. The advertising wall generating method according to claim 11, wherein the filtering condition comprises a filtering date and the advertising message corresponds to a due date; if the filtering date is later than the due date, this indicates that the advertising message is an expired advertising message; if the filtering date is later than the due date and there are no newly added advertising messages, the expired advertising message is selected; if the expired advertising message is shown in an external user end, the expired advertising message is covered with a semi-transparent filter.
